(19) United States
(12) Patent Application Publication
(10) Pub. No.: US 2008/0071520 A1
(43) Pub. Date: Mar. 20, 2008

(54) METHOD AND SYSTEM FOR IMPROVING THE WORD-RECOGNITION RATE OF SPEECH RECOGNITION SOFTWARE

(76) Inventor: David Lee Sanford, Seattle, WA (US)

Correspondence Address: AXIOS LAW GROUP. PLLC, 1525 FOURTH AVENUE, SUITE 800, SEATTLE, WA, 98101, US

(21) Appl. No.: 11/532,074

(22) Filed: Sep. 14, 2006

(51) Int. Cl. G06F 17/27

(52) U.S. Cl. 704/9

(57) ABSTRACT

A Method and System for Improving the Word-Recognition Rate of Speech Recognition Software are provided herein.

### FIELD

The present invention relates to the recognition of human spoken language by a computer program, that is, speech recognition.

### BACKGROUND

Speech recognition is the process of converting an audio signal carrying speech information into a set of words. Previous forms of speech recognition have included “isolated-word” speech recognition systems that require a user to pause briefly between words, whereas a continuous speech recognition does not. Previous attempts to create a robust speech recognition system have provided inadequate results.

Current speech recognition software, such as that developed by Carnegie Mellon University of Pittsburgh, Pa. (“CMU”) and the Massachusetts Institute of Technology, Cambridge, Mass. (“MIT”), divides the task of speech recognition into separate subtasks. First, they analyze the phonemic pattern of the utterance to determine likely words being spoken; they use a probabilistic technique, such as Hidden Markov Modeling, to decide what the most probable words are. Second, they submit the highest probability lists of words to an analysis of syntactic patterns, by attempting to parse the words, in order to decide which list of words constitutes a valid natural language sentence.

This division into two separate subtasks is done for various reasons. First, the technologies involved in phonemic and syntactic analyses are significantly different from each other and there is a natural psychological desire to keep such separate activities isolated from each other. Second, the parsing procedure generally assumes you have a whole sentence to parse, while the phonemic analysis procedure is working with incomplete utterances to try to determine the words that may eventually constitute a sentence.

In one example scenario, working with the SPHINX2 speech recognizer, developed by CMU, the program was tasked to decide what was said when a speaker uttered the sentence, “I WANT TO GO TO L. A.” The program computed that more likely interpretations of the speaker's utterance included the following:
I THE THE GOAT L A
I WANT THE BUILDER THE LAY
I THE TO GOTTEN ALL A
I WANT THE GO 'TIL A

When trying to decide what words are being spoken by a speaker, a computer program is building a graph structure 100. This graph is a data structure of possible words based on the sounds being made and their associations to words as uttered. An example graph 100 is illustrated in FIG. 1.

The zeroth word 110 is a token representing the start of a sentence. The first word 120 can be any of a set of alternatives. The second word 130 is likewise a set of alternatives, but restricted to following a particular first word. Although the graph 100 does not show the alternatives that can follow all first words, each of the first word alternatives has a set of second word alternatives that may follow, based on the probabilities of phoneme combinations compared to the incoming sound stream.

Each word in the graph 100 has an associated probability, computed by comparing the phonemes' models against the portion of the sound stream being analyzed. Then, each node along a path of the graph 100 has an associated probability, computed by multiplying together the probabilities of the words along that path up to that node. Eventually, the probabilities of many paths get so small, they are dropped from consideration. So, only some of the paths through the graph structure end up linking with the end sentence token. These are considered to be phonemically probable sentences, but then must be checked for being syntactically valid by a natural language parser. An example single path 200 through the graph of possible sentences is illustrated in FIG. 2.

Conceptually, the data flow of current speech recognizers is shown in FIG. 4. The analog sound waves 405 are taken in by a microphone 345 and sent to a Digitizer 360 (e.g., a computer's sound card). Typically, the Digitizer 360 takes samples of the analog signal 405 at a rate of 100 frames per second and converts 410 them into a digital representation of the waveform. Those digitized frames 415 are sent to a Phoneme Matcher 500, which compares the frames 415 to models of phonemes 530. As phoneme hypotheses 425 are developed, they are sent to a Word Matcher 600, that (using a word comparator 630) compares the phonemes 425 to models of spoken words in light of previously used phonemes 610. Finally, as word hypotheses 430 are developed 435, they are stored in a graph 365 of word strings that will be submitted to a parser once whole sentence hypotheses are available.

The Phoneme Matcher 500 is further divided into subtasks shown in FIG. 5. As each frame 415 is brought into the Phoneme Matcher 500, it is subjected to some preliminary statistical processing in the statistical processor 510. When speaking at a normal rate of delivery, the longest duration phoneme usually lasts around ⅓ of a second; but by drawing out the sound of words, phonemes can be extended for much longer than that. Nevertheless, even the shortest duration phoneme usually takes over 1/10 of a second to utter. Since the frames 415 are usually coming in at a rate of 100 per second, it takes 11 or 12 frames to capture a small phoneme. Accordingly the frames 415 may be stored temporarily until enough have been accumulated to make a hypothesis about what phoneme is being uttered through the current set of frames 520. Once enough frames 415 have been accumulated, they can be statistically compared by the statistical comparator 540 to the phoneme models 530 to decide which phonemes are most likely to be represented by the frame set. These phoneme hypotheses 425 are forwarded on to the next processing step, as shown in FIG. 6.

The Word Matcher 600 is divided into subtasks in FIG. 6. There are a few words that are composed of just a single phoneme, such as “I” and “a”. However most words are composed of multiple phonemes. Therefore, the phoneme hypotheses 425 must be accumulated until enough are acquired to make hypotheses about what word is being spoken. As the phoneme sets 610 are built up, they are statistically compared, by the word comparator 630 to word models 620, to decide which words are most likely being uttered by the speaker. As the word hypotheses 435 are developed, they are stored in a word graph 365. Once the graph 365 has a set of word lists, current systems next send the word lists to a parser (not shown) to determine which word lists form valid sentences. However, such systems occasionally fail to determine the correct sentence as they have already discarded the correct sentence.

In various embodiments different types of natural language parsers may be used. Parsers, in general, are divided into two types: top down (e.g., LL and recursive descent parsers), and bottom up (e.g., LR, SLR, and LALR parsers). The top down parser starts with the top of the grammar rule set and re-writes it into rules that match the input. The bottom up parser starts with the input words and rewrites them into rules that match the rule set defined by the grammar. Parsers are also identified by how many words they look ahead to figure out whether a parse is possible. LL(0) and LR(0) parsers use no lookahead. LL(1) and LR(1) parsers look ahead one word. For ambiguous language parsing, including natural language parsing, an LL(3) parser may be used, if one wishes to use a top down parser. Alternately, an LR(1) parser may be used. Not only is an LR(1) parser less complex that an LL(3) parser, it is usually faster than an LR(0) parser.

One weakness of the conventional speech recognition systems described above is that it has been difficult to develop a sufficiently reliable method of speech recognition. The systems developed so far are able to recognize correctly, at most, only around 95% to 98% of the words spoken. These are still not acceptable recognition rates for a speech recognition system.

### BRIEF DESCRIPTION OF THE DRAWINGS

The present invention will be described by way of exemplary embodiment, but not limitations, illustrated in the accompanying drawings in which like references denote similar elements, and in which:

FIG. 1 is a pictorial diagram of a graph structure in accordance with one embodiment.

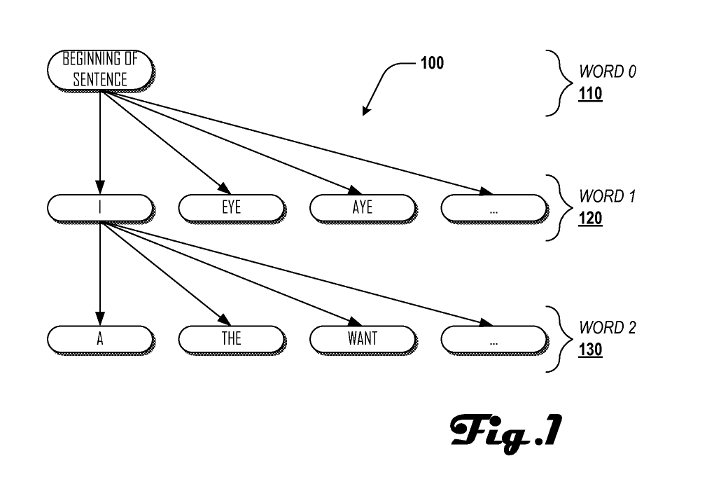

FIG. 2 is a block diagram of a parse tree in accordance with one embodiment.

FIG. 3 is a block diagram of a user device that provides an exemplary operating environment for various embodiments.

FIG. 4 is a diagram illustrating the actions taken by a user device in a speech recognition system in accordance with prior art embodiments.

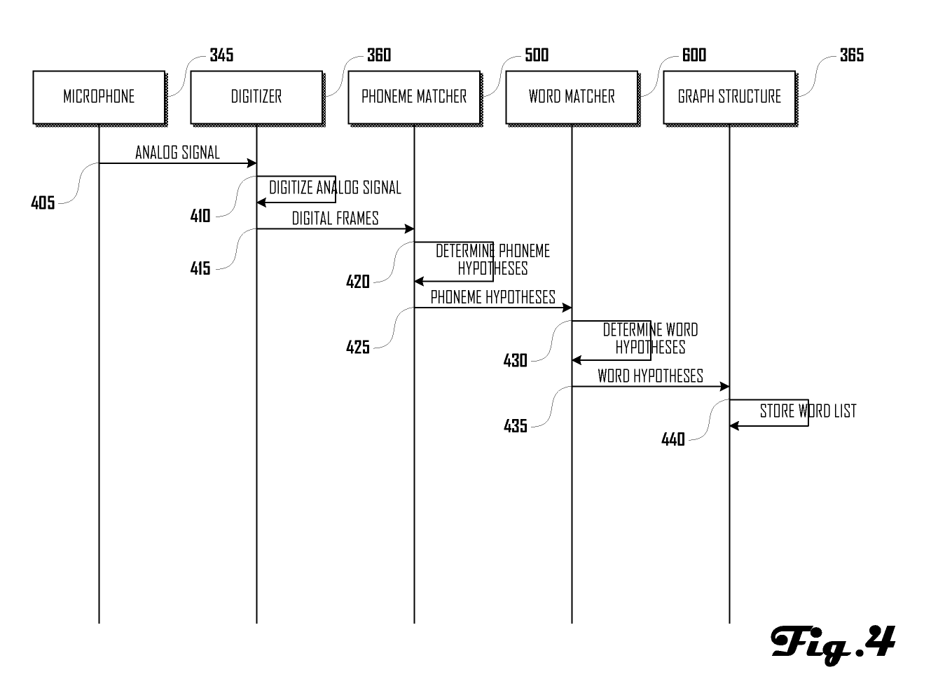

FIG. 5 is a diagram illustrating components of a phoneme matcher in accordance with conventional embodiments.

FIG. 6 is a diagram of components of a word matcher in accordance with conventional embodiments.

FIG. 7 is a diagram illustrating the actions taken by components of a user device for speech recognition in accordance with various embodiments.

FIG. 8 is a diagram illustrating components of a natural language parser in accordance with one embodiment.

FIG. 9 is a flow diagram illustrating a speech recognition routine in accordance with various embodiments.

FIG. 10 is a flow diagram illustrating a natural language parsing subroutine in accordance with one embodiment.

FIG. 11 is a natural language parsing subroutine in accordance with an alternate embodiment.

### DETAILED DESCRIPTION

The detailed description that follows is represented largely in terms of processes and symbolic representations of operations by conventional computer components, including a processor, memory storage devices for the processor, connected display devices and input devices. Furthermore, these processes and operations may utilize conventional computer components in a heterogeneous distributed computing environment, including remote file Servers, computer Servers and memory storage devices. Each of these conventional distributed computing components is accessible by the processor via a communication network.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to or combined without limiting the scope to the embodiments disclosed herein.

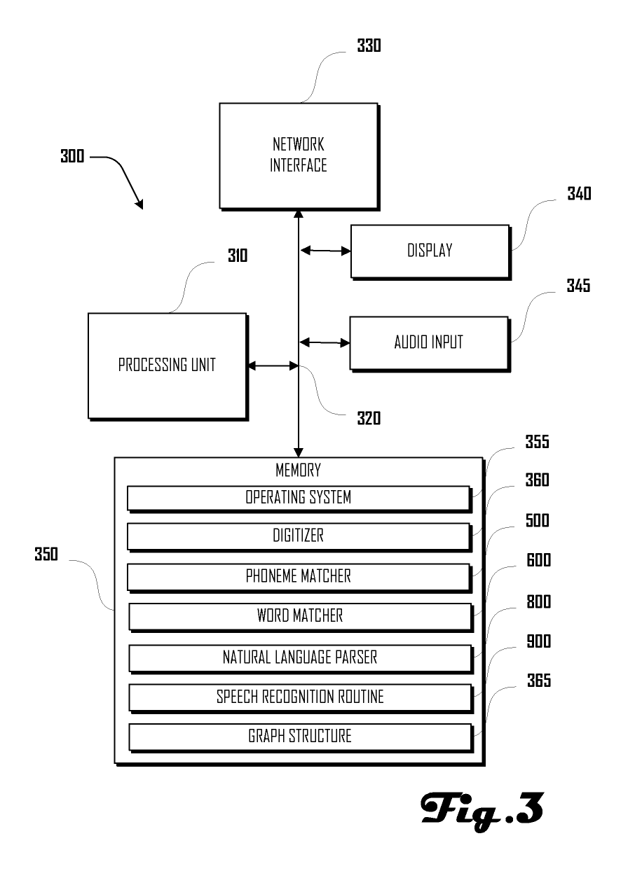

FIG. 3 illustrates several components of the user device 300. In some embodiments, the user device 300 may include many more components than those shown in FIG. 3. However, it is not necessary that all of these generally conventional components be shown in order to disclose an illustrative embodiment. As shown in FIG. 3, the user device 300 includes a network interface 330 (e.g., for connecting to the network, not shown). Those of ordinary skill in the art will appreciate that the network interface 330 includes the necessary circuitry for such a connection and is constructed for use with an appropriate protocol.

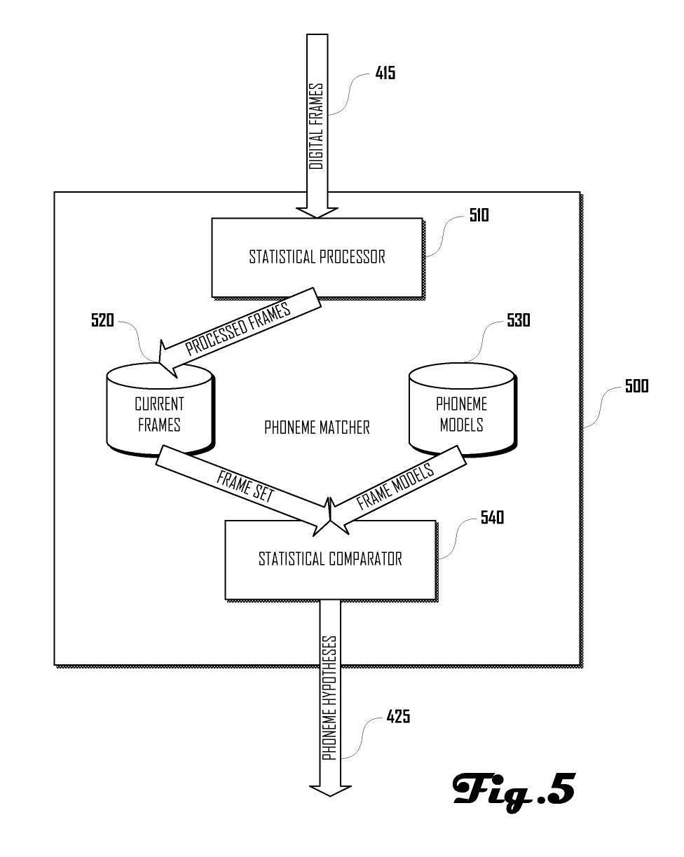

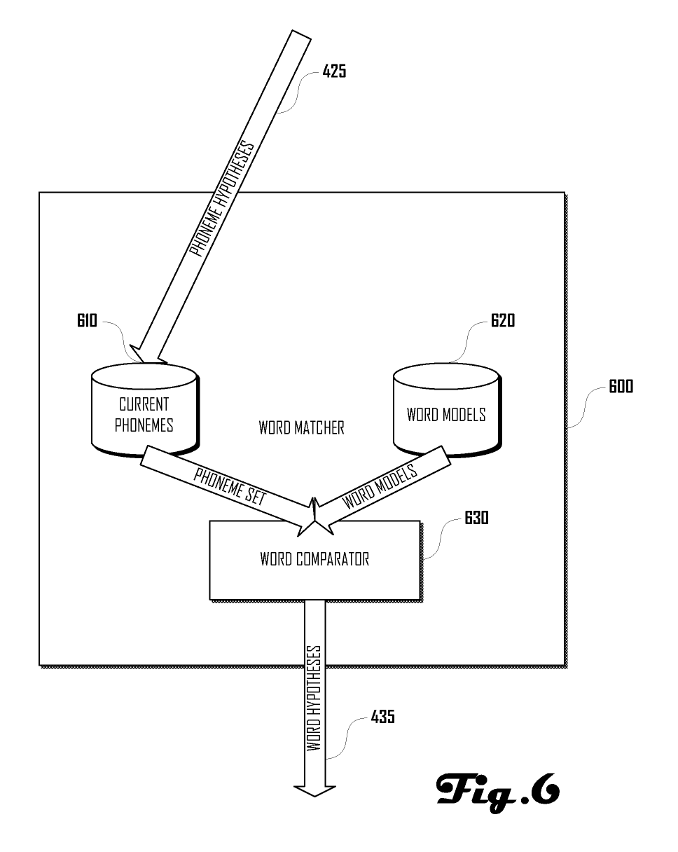

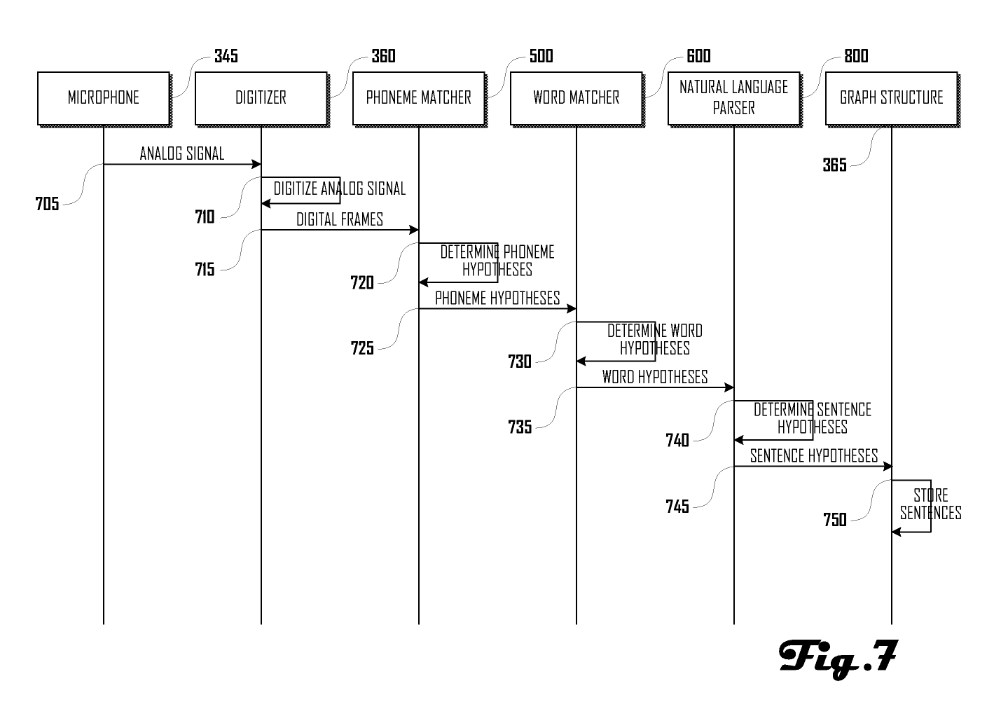

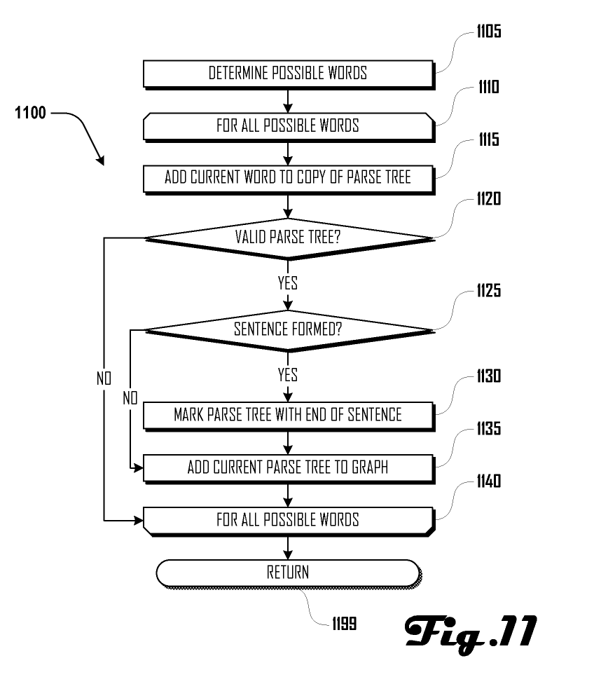

The user device 300 also includes a processing unit 310, a memory 350, and may include an optional display 340 (or visual/audio indicators), and an audio input 354 (possibly including a microphone and sound processing circuitry) all interconnected along with the network interface 330 via a bus 320. The memory 350 generally comprises at least one or more of a random access memory (“RAM”), a read only memory (“ROM”), flash memory, and a permanent mass storage device, such as a disk drive. The memory 350 stores program code for a digitizer 360 (alternately the digitizer may be part of the audio input 345), phoneme matcher 500 (illustrated in FIG. 5, and described above), word matcher 600 (illustrated in FIG. 6, and described above), natural language parser 1100 (illustrated in FIG. 11, and described below), speech recognition routine 700 (illustrated in FIG. 7, and described below) and a graph structure 365. In addition, the memory 350 also stores an operating system 355. It will be appreciated that these software components may be loaded from a computer readable medium into memory 350 of the user device 300 using a memory mechanism (not shown) associated with a computer readable medium, such as a floppy disc, tape, DVD/CD-ROM drive, memory card, the network interface 330 or the like.

Although an exemplary user device 300 has been described that generally conforms to a conventional general purpose computing device, in alternate embodiment a user device 300 may be any of a great number of devices capable of processing spoken audio, such as a personal digital assistant, a mobile phone, an integrated hardware device and the like.

In various embodiments, the subtasks of phonemic and syntactic analysis may be combined to improve speech recognition quality. Such a combination of subtasks utilizes a natural language parser that must be bottom up and designed to handle data storage as if it were thread-safe. One such parser may be described as an LR(O) parser that is thread-safe and re-entrant. For simplicity's sake, various embodiments described below may be in terms of an LR(0) parser, but such explanations are not meant to be limiting, especially with regard to other forms of parsers, such as LR(1) parsers and the like.

Conceptually, the LR(0) parser has a single function that takes a list of words in and outputs a parse tree, or outputs nothing if the words submitted are not able to be parsed using the grammar defined for the parser. An example signature for a software method might look like this:
struct parsetree*parse(struct word*headOfWordList);

This example assumes the word list is a linked list of word structures. But it could be an array or stack of words, or any other suitable data structure. Similarly, the output parse tree could be any suitable data structure capable of representing a parse tree.

Many conventional parse functions are designed differently. For example, “yacc” and “bison” programs used by UNIX systems call a function which has the following signature:
int yyparse(void);

The “int” return value is a success or error code. The input word list and output parse tree are stored as global variables. This prevents yacc and bison from being thread-safe and re-entrant. However conceptually, yacc and bison provide similar functionality to the signature above.

For a thread-safe and re-entrant parser, the signature might be something like this:
int parse(struct word*headOfWordList, struct parseTree*parseTreeOut);

That is, the storage for the output is passed in to the function along with the collection of words to be parsed.

However, inside such a parse function, the action is not applied to the entire collection of words all at once. Inside the parse function is a loop that adds each word to the parsing process one at a time, like this:

```
    struct word *currentWord = headOfWordList;
    while (NULL != currentWord)
    {
        int rc;
        if (SUCCESS != (rc = addNextWordToParse(currentWord,
parseTreeOut)))
        {
            return rc;
        }
        currentWord = currentWord->next;
    }
    return SUCCESS;
```

Suppose the collection of words input to the parse function does not constitute a valid sentence in the grammar. At some point in the parsing process, the attempt to add the current word to the parse will fail, that is, the function addNextWordToParse( ) will return a non-SUCCESS return code. When that happens, the loop is discontinued by returning that non-SUCCESS return code as the answer to the parse( ) function and further attempts to add words to the parse will be aborted.

Accordingly, in one embodiment, the structure of the graph of possible utterances includes the storage used to hold a parse tree. As each word is added to the graph, its parse tree is computed to that point. So the structure for a word in the graph of possible utterances would look like this:

```
struct wordInGraph_s
{
    struct word *word;
    struct wordInGraph_s *previousWord;
    struct parseTree *parseTreeToHere;
};
```

When a word is proposed as an entry in the graph of possible utterances, the parseTreeToHere of the previousword is copied to the parseTreeToHere of the current word, and the function addNextWordToParse( ) is called to see if there is a valid parse of the current word given the preceding words it is pointed at. It would look like this:

```
    memcpy(currentWord->parseTreeToHere,
        currentWord->previousWord->parseTreeToHere,
        sizeof(struct parseTree));
    addNextWordToParse(currentWord->word, currentWord->
parseTreeToHere);
```

Therefore, in the example sentences given above, “I THE THE GOAT L A” would fail to parse at the third word, instead of continuing to the end. And, likewise, the sentence “I THE TO GOTTEN ALL A” would fail at the third word. But, “I WANT THE GO 'TIL A” would fail on the fourth word. Parsing as words are added eliminates syntactically invalid word lists and allows only syntactically valid utterances to rise to the top of the choices for the sentence being uttered.

In alternate embodiments the use of the C library function “memcpy” was not used, rather another suitable copying method may be used.

The previous explanation assumed that an LR(0) parser was being used.

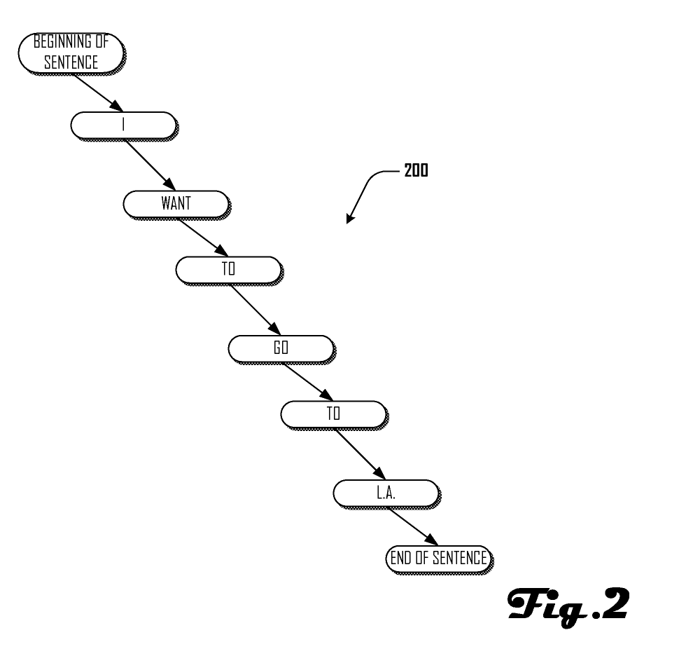

In such an LR(0) embodiment, each candidate word is proposed to a given path of words in the word graph being built. The parse of the previous words would be copied and the current candidate word would be added to the parse to see if the new word is a valid addition to the parse tree developed so far. So, in the example in FIG. 2, when the second word “WANT” is proposed as a word to follow the first word “I”, the parse tree for the first two tokens (i.e., “BEGINNING OF SENTENCE” and “I”) is copied into place and the parser is called to try to add the new word to the parse tree.

However, since LR(1) parsers are generally faster than LR(0) parsers, one might prefer to use an LR(1) parser. In such an LR(1) embodiment, the parse of the first word “I” is delayed until the second word is available, and the second word is used as the “lookahead” word for the parsing of “I”. This would cause the parse to lag by one word in the graph of words being built, but the gain in parsing speed by using an LR(1) parser might be worth the delay. Likewise, a similar approach may be extended to LR(2) parsers and beyond. In such further embodiments, the parse step is delayed until enough lookahead words have been acquired.

Accordingly, by adding another step to the speech recognizer, as shown in FIG. 7 it is possible to increase the accuracy of speech recognition. FIG. 7 illustrates exemplary communications between components of a speech recognition system in accordance with various embodiments. A user speaks into a microphone 345, which sends an analog signal 705 to a digitizer 360. The digitizer digitizes the analog signal 710 and sends the resulting digital frames 715 to a phoneme matcher 500. The phoneme matcher determines 720 hypothetical phonemes and sends the phoneme hypothesis 725 to a word matcher 600. The word matcher 600 determines 730 word hypothesis and sends the word hypothesis 735 to a natural language parser 800. The natural language parser determines hypothetical sentences and sends the sentence hypothesis 745 to the graph structure 365 where they are stored as possible sentences 750.

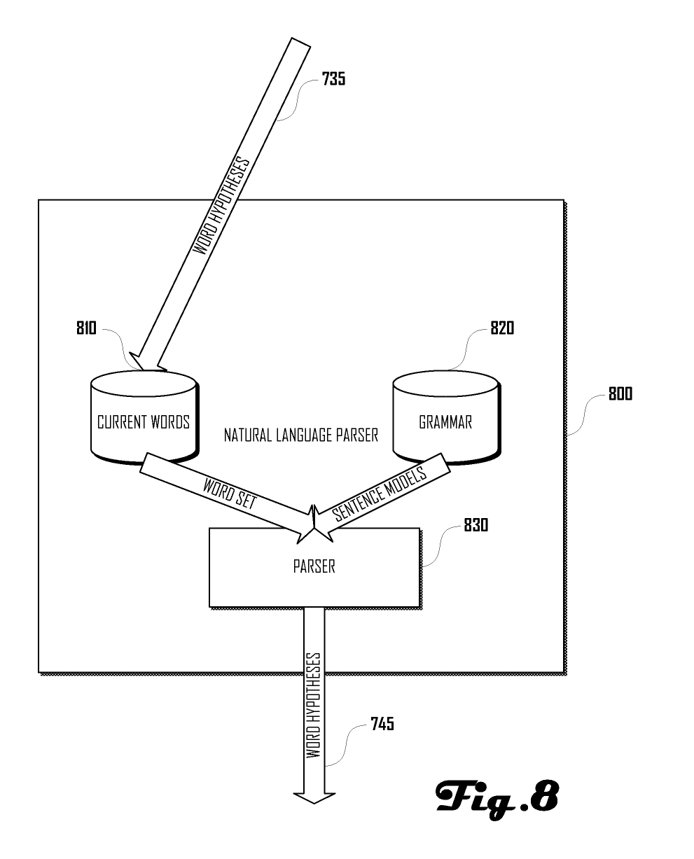

The natural language parser 800 is further divided into subtasks as shown in FIG. 8, As each word hypothesis 735 is about to be added to the word graph 365, the parser 830 is called to check whether the path through the graph 365 to the current word hypothesis 810 is syntactically valid, via grammar 820. Many possibilities would be rejected this way and only syntactically valid paths through the word graph 365 would eventually emerge from the speech recognition processor.

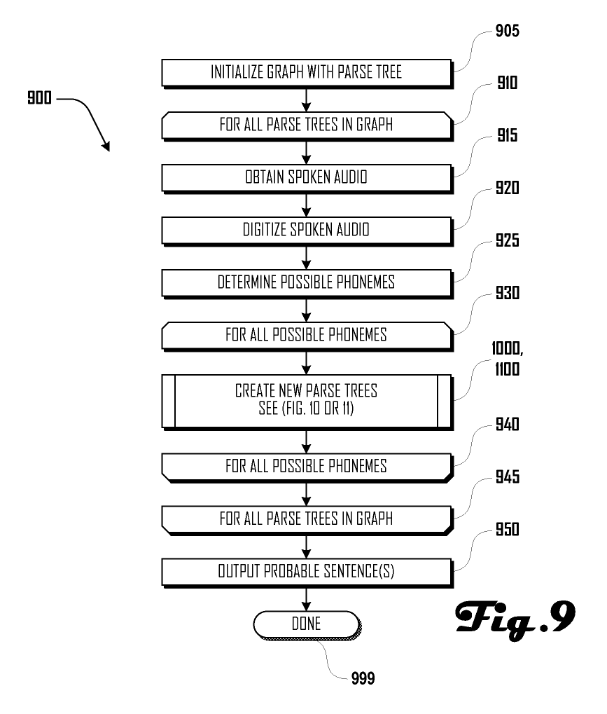

FIG. 9 illustrates an exemplary speech recognition routine 900. The speech recognition routine 900 begins at block 905 where a graph structure 365 is initialized with a parse tree. In one exemplary embodiment, the parse tree contains a beginning of sentence word already placed in its zeroth position. Next in looping block 910 the speech recognition routine 900 begins an iteration through all parse trees in the graph structure 365. In block 915 spoken audio is obtained. In some embodiments the audio may be received in real time from a speaker speaking into a microphone, however in other embodiments the audio may be obtained from a recorded or otherwise stored audio signal. In block 920 the spoken audio is digitized (assuming it was not obtained in digital form already). Next in block 925 a determination of possible phonemes is made for the digitized audio (possibly in combination with previously stored “frames” of digitized audio. Next, in looping block 930, an iteration through all possible phonemes begins. Processing proceeds to new parse tree creation subroutine 1000, 1100 where an attempt is made to form new parse trees given the possible phonemes. Upon returning from the new parse tree creation subroutine 1000, 1100 processing proceeds to looping block 940, which cycles back to looping block 930 until all possible phonemes have been iterated through. After which, processing proceeds to looping block 945 where all parse trees in the graph are iterated through by cycling back to looping block 910. Once all parse trees in the graph structure 365 have been iterated through (including any parse trees that were created during the process), processing proceeds to block 950 where the probable sentence(s) in the graph structure 365 are output. Speech recognition routine 900 ends at block 999.

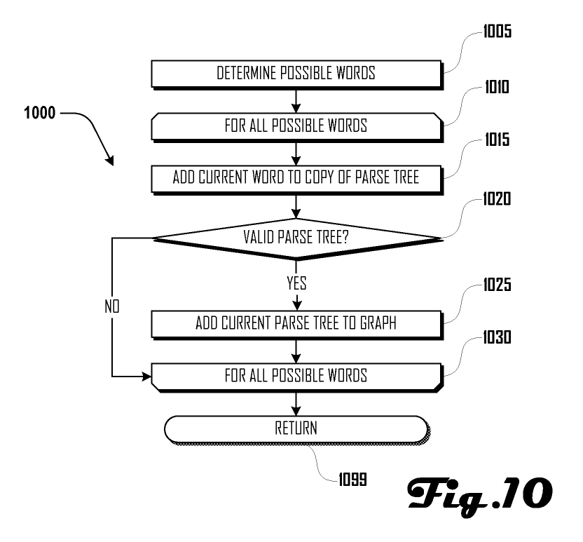

FIG. 10 illustrates an exemplary new parse tree creation subroutine 1000. New parse tree creation subroutine 1000 begins at block 1005 where a determination is made of all possible words that may be formed given the phonemes presented to new parse tree creation subroutine 1000. Next in looping block 1010 an iteration begins for all possible words that were determined in block 1005. In block 1015 an attempt is made to add the current words to a copy of the current parse tree. In decision block 1020 a determination is made whether the copy of the current parse tree with the current word added is a valid parse tree. If so processing proceeds to block 1025 where the copy of the parse tree with the added word is added to the graph structure. If, in decision block 1020, it was determined that the current word added to a copy of the parse tree does not create a valid parse tree, processing proceeds to looping block 1030, which cycles back to looping block 1010 until all possible words have been iterated through. After which, processing proceeds to return block 1099 where subroutine 1000 returns to its calling routine.

In some embodiments, such as those using exemplary parse tree creation subroutine 1000, the end of a sentence is determined by a pause of a predetermined length (e.g., one second or longer) during the speech recognition process. A speech recognition system may treat silence as either indications of a pause or as an indication of an end of sentence. It will be appreciated that under most circumstances adding a “word” of silence into a sentence would not make that sentence grammatically invalid. However adding in end of sentence prematurely may be considered grammatically invalid and would not be accepted in decision block 1020.

FIG. 11 illustrates an alternate parse tree creation subroutine 1100, which does not have to use pauses between sentences as indications of an end of sentence. New parse tree creation subroutine 1100 begins at block 1105 where a determination is made of all possible words that may be formed given the phonemes presented to new parse tree creation subroutine 1100. Next in looping block 1110 an iteration begins for all possible words that were determined in block 1105. In block 1115 an attempt is made to add the current words to a copy of the current parse tree. In decision block 1120 a determination is made whether the copy of the current parse tree with the current word added is a valid parse tree. If so processing proceeds to decision block 1125 where determination is made whether a grammatically correct sentence has been formed. If so processing proceeds to 1130 where the copy of the parse tree with the current word added is marked with an end of sentence and in block 1135 that parse tree is added to the graph structure 365. If, however, in decision block 1125 it was determined that a sentence was not formed, processing proceeds directly to block 1135. Returning to decision block 1120 if it was determined that the parse tree is invalid, processing proceeds to looping block 1140. Likewise after adding a current parse tree to the graph structure 365 in block 1135, processing also proceeds to looping block 1140, which cycles back to looping block 1110 until all possible words have been iterated through. After which, processing proceeds to return block 1199, which returns to the calling routine.

This method and system for improving the word recognition rate of speech recognition software will work with existing parser technology. To maximize effectiveness, the parser used with this method should be thread-safe and re-entrant. In one example embodiment, to increase efficiency, a fast parser may be employed. Since there are a lot of word hypotheses generated by speech recognition software, using a slow parser would add a lot of time to the process. However, with a fast parser, the overall task would be much quicker. Additionally, on a Symmetrical Multi-Processing (“SMP”) system, the parsing tasks could be threaded to be performed simultaneously, rather than sequentially, thereby speeding up the recognition process even more.

Although specific embodiments have been illustrated and described herein, it will be appreciated by those of ordinary skill in the art that a wide variety of alternate and/or equivalent implementations may be substituted for the specific embodiments shown and described without departing from the scope of the present invention. This application is intended to cover any adaptations or variations of the embodiments discussed herein.

What is claimed is:

1. A computer implemented method of recognizing digitized speech, the method comprising:
for each possible parse trees in a candidate sentence structure performing steps (a)-(c):
a. obtaining a digitized portion of speech;
b. determining possible phonemes comprising said digitized portion of speech; and
c. for each possible phoneme performing steps (1)-(2):
1. determining possible words comprising a current possible phoneme; and
2. for each possible word performing steps (i)-(ii)
i. determine if adding current word to a copy of a current parse tree forms a valid parse tree; and
ii. if adding current word to a copy of a current parse tree forms a valid parse tree, adding said valid parse tree to said candidate sentence structure; and
determining a recognized sentence from said candidate sentence structure.

2. The method of claim 1 wherein said possible parse trees comprise data structures selected from at lease one of: arrays, linked lists, vectors, strings, object oriented classes and files.

3. The method of claim 1 wherein said digitized portion at speech is an audio frame.

4. The method of claim 3 wherein said audio frame comprises a representation of between 0.1-0.0001 seconds of audio information.

5. The method of claim 1 wherein a possible parse tree comprises a valid parse tree that does not already have an indication of an end-of-sentence.

6. The method of claim 5 wherein said indication of an end-of-sentence comprises an end-of-sentence added to a parse tree.

7. The method of claim 6 wherein adding said end-of-sentence word to said parse tree comprises determining that said speech comprises a parse of a predetermined length.

8. The method of claim 6 wherein adding said end-of-sentence word to said parse tree comprises determining that a grammatically complete sentence has been formed.

9. The method of claim 1 wherein a possible phoneme comprises a phoneme whose component portion or portions of speech have not been used by a previously determined phoneme at a current parse tree.

10. The method of claim 1 wherein a possible word comprises a word whose component possible phoneme or phonemes have not been used by a previously determined word of a current parse tree.

11. The method of claim 1 wherein determining possible phonemes comprises a probability check.

12. The method of claim 1 wherein determining possible words comprises a probability check.

13. The method of claim 1 wherein determining a recognized sentence comprises a probability check.

14. The method of claim 1 further comprising determining an end of sentence.

15. The method of claim 14 wherein determining an end of sentence comprises detecting a period of silence.

16. The method of claim 14 wherein determining an end of sentence comprises determining if a complete sentence has been formed by a current parse tree.

17. A computer-readable medium comprising computer-executable instructions for performing the method of claim 1.

18. A computing apparatus comprising a processor and a memory having computer-executable instructions, which when executed, perform the method of claim 1.

19. The method of claim 18 wherein the computing apparatus comprises a plurality of processors and the computer-executable instructions are executable across a plurality of the processors.

20. The method of claim 18 wherein the computing apparatus is a Symmetrical Multi-Processing system.

21. A computer implemented method of recognizing digitized speech, the method comprising:
for each possible sentence in a candidate sentence structure performing steps (a)-(c):
d. obtaining a digitized portion of speech;
e. determining possible phonemes comprising said digitized portion of speech; and
f. for each possible phoneme performing steps (1)-(2):
1. determining possible words comprising a current possible phoneme; and
2. for each possible word performing steps (i)-(ii)
i. adding current word to a said possible sentence; and
ii. determining if said possible sentence forms a valid parse tree; and
determining a recognized sentence from said candidate sentence structure.
